(19) United States
(12) Patent Application Publication
(10) Pub. No.: US 2021/0094451 A1
(43) Pub. Date: Apr. 1, 2021

(54) DEVICE FOR THE HEIGHT ADJUSTMENT OF A VEHICLE SEAT

(71) Applicant: Aguti Produktentwicklung & Design GmbH, Langenargen (DE)

(72) Inventor: Christian ROGG, Wasserburg (DE)

(73) Assignee: Aguti Produktentwicklung & Design GmbH, Langenargen (DE)

(21) Appl. No.: 16/583,571

(22) Filed: Sep. 26, 2019

(51) Int. Cl. B60N 2/50

(52) U.S. Cl. CPC B60N 2/505; B60N 2/507

(57) ABSTRACT

Device for the height adjustment of a vehicle seat, wherein the device comprises a lower part for arranging on a vehicle, wherein the device has an upper part for arranging a vehicle seat and/or for arranging a rotary unit for a vehicle seat, wherein the lower part and the upper part are coupled together via an actuating arm, wherein the device has a damping member. The device is characterized in that the damping member is present between the upper part and the lower part, wherein the damping member is configured to alter a spacing of the upper part relative to the lower part and wherein the device comprises a spring element and the spring element is present on the device such that it acts counter to a direction of extension of the damping member.

### FIELD OF THE INVENTION

The present inventions relates to a device for the height adjustment of a vehicle seat.

### BACKGROUND OF THE INVENTION

Devices for the height adjustment of a vehicle seat are already known.

A known device for the height adjustment of a vehicle seat is able to be arranged between a vehicle and the vehicle seat and comprises an upper part which is present so as to be height-adjustable relative to a lower part, wherein the lower part and the upper part are movably coupled together via connecting elements. Moreover, an adjusting unit in the form of an actuating cylinder is present between the lower part and the upper part in order to adjust a spacing between the lower part and the upper part and to dampen vibrations which occur when the vehicle is traveling.

A drawback with such a device is that, in particular, in the case of large vibration amplitudes which may occur during travel, a damping apparatus of the device reaches a lower stop and/or an upper stop of the adjusting unit and the vehicle seat is sharply braked thereon in a manner which is disadvantageous and potentially painful for a user of the vehicle seat.

### SUMMARY OF THE INVENTION

The object of the present invention is to provide an improved device for the height adjustment of a vehicle seat, in particular, an improved device for damping vibrations which occur.

The present invention is based on a device for the height adjustment and/or the damping of a vehicle seat, wherein the device comprises a lower part for arranging on a vehicle, wherein the device has an upper part for arranging a vehicle seat and/or for arranging a rotary unit for a vehicle seat, wherein the lower part and the upper part are coupled together via an actuating arm, wherein the device has a damping member.

A vehicle in which the vehicle seat is advantageously able to be arranged with such a device for the height adjustment and/or for the suspension of the vehicle seat is configured, for example, as an automobile, for example, as a truck, as a construction vehicle, as a bus, as a van, as a campervan, as a motorhome and/or as a caravan. It is also conceivable that the vehicle is designed as a camper and/or as a camper trailer.

The vehicle seat may be present as a driver's seat or front passenger seat and is able to be arranged, in particular, in a front region of the vehicle. It is also conceivable that the vehicle seat is able to be arranged in a rear region of the vehicle. The vehicle seat is designed, for example, as an individual seat, for example, as a driver's seat.

The essential feature of the present invention is that the damping member is present between the upper part and the lower part, wherein the damping member is configured to alter a spacing of the upper part relative to the lower part and wherein the device comprises a spring element and the spring element is present on the device such that it acts counter to a direction of extension of the damping member.

The damping member is advantageously configured as a pneumatic and/or hydraulic damping unit. The damping member is present, for example, as an air bellows or spring bellows, for example, as a simple sealed tube, for example, as a rubber tube. Advantageously, the damping member is present so as to be expandable and/or movable in a plurality of spatial directions. The damping member is provided, in addition to a height adjustment of the vehicle seat, amongst other things, for damping vibrations which occur during travel, between the lower part and the upper part, for example, between the vehicle seat and the vehicle.

The damping member is fixed, for example, in a positionally fixed manner to the upper part and/or to the lower part, for example, mounted thereon. The damping member is advantageously present on the device such that when the damping member extends in the direction of extension, a spacing between the upper part and the lower part is increased thereby.

The spring element is configured, for example, as a spiral spring, in particular, a flat spiral spring, a leg spring, a rotary spring and/or torsion spring, for example, as a torsion bar spring. It also proves advantageous if two or more spring elements, in particular, just two spring elements or, in particular, just four spring elements, are present on the device.

It also proves advantageous if the device has two or more actuating arms, wherein the upper part and the actuating arms are arranged, for example, in a parallelogram-like manner and are present so as to be adjustable relative to one another. Advantageously, the upper part and the actuating arms form a parallelogram.

Preferably, the device comprises three, four or, in particular, six actuating arms. If the device has two or more actuating arms, in particular, six actuating arms, for example, in each case two actuating arms are present so as to be parallel, in particular, movably parallel, to one another. For example, the movements of two actuating arms are synchronized via a mechanism of the device. For example, four actuating arms of the six actuating arms are fixed in a rotationally movable manner to the lower part. The two remaining actuating arms of the six actuating arms are present, for example, so as to be oriented parallel to the upper part.

Due to the parallelogram-like arrangement of the upper part and the actuating arms, when the vertical spacing of the upper part relative to the lower part is altered, a first actuating arm has a horizontal movement direction component, in particular, exclusively a horizontal movement direction component, relative to the lower part. The alteration to the vertical spacing may be a height adjustment of the upper part relative to the lower part. The first actuating arm is advantageously configured to be able to oscillate relative to the lower part.

If the damping member is fastened, for example, to the upper part and to the lower part, it is subjected, for example, to a horizontal distorsion and/or a horizontal displacement during a height adjustment.

It is also conceivable that the device has two or more actuating arms, in particular, four actuating arms, wherein the actuating arms are present in a scissor-like manner on the device. Advantageously the device comprises a scissor-like mechanism or a scissor-like adjustment, wherein the actuating arms are part of the scissor-like mechanism or the scissor-like adjustment. The actuating arms are advantageously configured as levers and/or have a lever function.

It is also advantageous if the spring element is arranged on the lower part.

For example, the spring element is supported on the lower part, for example, the spring element is fastened, in particular, fixed, to the lower part. If the spring element is arranged on the lower part, the spring element acts, in particular, such that the upper part coupled to the actuating arm is forced, for example, pulled, in the direction of a minimum spacing between the lower part and the upper part. Advantageously, the spring element acts on an actuating arm of the device, in particular, the spring element acts directly or immediately on an actuating arm of the device.

It is also conceivable that the spring element is fastened to an actuating arm and/or to the upper part. For example, the spring element is present on the device such that it acts between two actuating arms and/or an actuating arm and the upper part and/or a plurality of actuating arms and the upper part. It is conceivable that a rotational axis of the spring element is present so as to be parallel to a pivot pin, in particular, a rotary pin, of an actuating arm.

It is further proposed that the upper part is movably mounted between a stop of the spring element, in particular, an end stop of the spring element, and a stop of the damping member, in particular, an end stop of the damping member, in particular, in a sprung and/or damped manner.

Advantageously the stop of the damping member forms a lower stop of the device and the stop of the spring element forms an upper stop of the device. In the arranged state of the device, “below” is understood as a region in the direction of the substrate on which the vehicle moves and “above” is understood as a direction opposing the downward direction, for example, in the direction of the vehicle roof of the vehicle and/or in the direction of the vehicle seat.

Preferably, the spring element and the damping member are configured and arranged on the device in a manner such that the upper part is movably mounted between a stop of the spring element and a stop of the damping member, in particular, damped, such that when deflected from a resting position and/or from a traveling position the upper part reaches neither of the two stops. A deflection from the resting position and/or from a traveling position may be caused due to an unevenness of the substrate on which the vehicle moves, the vehicle seat with the device being constructed therein. Advantageously, the device is configured such that irrespective of the degree of deflection neither of the two stops is reached by a deflection of the upper part.

Moreover, it is advantageous if the spring element is arranged between the lower part and a first actuating arm, in such a manner that the spring element acts counter to an extension of the damping member, for example, a volumetric extension and/or a deflection of the damping member.

Advantageously, the spring element is present on the device and/or designed and acts with a spring force counter to an extension force of the damping member in such a manner that the damping member does not reach a maximum extension, a maximum volume or a maximum deflection, in particular, an upper stop of the damping member.

In an advantageous embodiment of the device, a rotational axis of the spring element is present so as to be parallel to a direction of movement of the upper part.

Preferably, the rotational axis is present so as to be perpendicular to a bearing surface of the lower part on the vehicle or a bearing surface of the upper part for arranging the vehicle seat. For example, the rotational axis of the spring element is present so as to be configured to be perpendicular to a pivot pin of an actuating arm, in particular, perpendicular to all of the pivot pins of an actuating arm, for example, perpendicular to all of the pivot pins of all of the actuating arms. In particular, the rotational axis of the spring element is present so as to be oriented vertically.

It is also advantageous if the spring element is coupled to an actuating arm, in particular, the first actuating arm.

Advantageously, an end of the spring element is connected to an actuating arm, in particular, fixedly, i.e. unreleasably. For example, the end of the spring element is connected to the first actuating arm.

It is also conceivable that an end of the spring element is present so as to be guided on an actuating arm. It is also conceivable that the end partially acts on the actuating arm. For example, the spring element partially acts on the actuating arm and/or partially exerts a force on the actuating arm. For example, the spring element is configured to be coupled to a driver element of an actuating arm. For example, the spring element always acts with a force on the first actuating arm, in particular, in any position of the first actuating arm.

It is also proposed that a pivot pin, in particular, a rotary pin of an actuating arm, is present on the lower part in a positionally fixed manner.

For example, a second actuating arm is pivotably, in particular, rotatably, mounted on the lower part via a first pivot pin. It is also conceivable that the second and a third actuating arm are pivotably, in particular, rotatably, mounted on the lower part via the first pivot pin. It is also conceivable that the second actuating arm via the first pivot pin and the third actuating arm via a second pivot pin are pivotably, in particular, rotatably, mounted on the lower part.

Advantageously, the device is configured such that the second actuating arm and the third actuating arm pivot in an angular range, in particular, in a pivoting range, for example, a rotational range, between 0° and 70°, in particular, between 0° and 60°, about the first and/or the second pivot pin. For example, the second and the third actuating arm pivot in an angular range of approximately +/−35°, +/−30°, +/−25°, +/−20° or +/−15° about the respective pivot pin.

In particular, the pivot pins are present such that the upper part is movable relative to the lower part between a minimum spacing relative to the lower part and a maximum spacing relative to the lower part.

Advantageously, the pivot pin by which the second and the third actuating arm is movably received on the lower part, viewed in the direction of a longitudinal axis of the second and the third actuating arm, is located in a central region of the actuating arms. For example, the pivot pin by which the second and the third actuating arm is movably received on the lower part is located between a pivot pin by which the second and/or the third actuating arm is coupled to the upper part and a pivot pin by which the second and/or third actuating arm is coupled to the first actuating arm.

It is also advantageous if the device comprises at least six pivot pins.

Advantageously, the entire parallelogram-like arrangement comprises just six pivot pins. Preferably, in each case three pivot pins are configured on a pivot arm of the device, in particular, on the second and third actuating arm. Preferably, just two pivot pins are present on the first actuating arm. Advantageously, the actuating arms are all mounted in a rotationally movable manner on at least six pivot pins of the device.

Preferably, when the upper part moves relative to the lower part, just two, in particular, four, pivot pins of the device move along a circular path, in particular, along a part circle. For example, when the upper part moves relative to the lower part, two pivot pins of the device, in particular, just two pivot pins of the device, move about a rotational axis of a further pivot pin. For example, when the upper part moves relative to the lower part, in each case two pivot pins from, for example, four pivot pins, of the device, move around one respective rotational axis of a further pivot pin.

It is also advantageous if the upper part is present so as to be rotationally movable relative to the lower part.

Due to the parallelogram-like arrangement the upper part, when it moves relative to the lower part, for example, has both a vertical and a horizontal movement component, wherein the vertical movement component of the upper part, for example, a vertical movement path of the upper part, is configured to be relatively large in comparison with the horizontal movement component of the upper part, for example, a horizontal movement path of the upper part. Advantageously, when moved relative to the lower part, the upper part moves on a circular path, in particular, along a part-circular path and/or a part circle.

Advantageously, the upper part is coupled to the lower part via the second actuating arm and/or the third actuating arm in a rotationally movable manner.

It is also advantageous if a spring force of the spring element is present so as to be adjustable. For example, the spring element is present as a flat spiral spring and may be tensioned or released, in particular, without the use of tools, by a relatively simple rotation of the flat spiral spring, for example, by pulling on an end of the flat spiral spring fastened at the center of rotation.

For example, in particular, a self-locking adjusting mechanism is present, by which a spring force of the spring element may be adjusted for a user of the vehicle seat. For example, the spring force of the spring element is adjustable by rotating an adjusting element of the adjusting mechanism.

It is also proposed that the device comprises a switch which is designed to switch and/or to regulate an extension of the damping member. For example, the switch may be provided to control an electrical supply line to a pump which, for example, pneumatically acts upon the damping member. Moreover, it is conceivable that a valve is able to be switched by means of the switch in order to regulate or adjust a pressure inside the damping member.

### BRIEF DESCRIPTION OF THE DRAWINGS

An exemplary embodiment is described in more detail with reference to the following schematic drawings, specifying further details and advantages.

FIG. 1 shows a perspective view of a device according to the present invention obliquely to the side from the front;

FIG. 2 shows a perspective view of the device according to FIG. 1 obliquely to the side from the bottom rear;

FIG. 3 shows a rear view of the device according to FIG. 1;

FIG. 4 shows a side view of the device according to FIG. 1;

FIG. 5 shows a view from below of the device according to FIG. 1; and

FIGS. 6 and 7 show in each case a sectional view through the device according to FIG. 1 corresponding to the cutting lines A, B shown in FIG. 5.

### DETAILED DESCRIPTION OF THE INVENTION

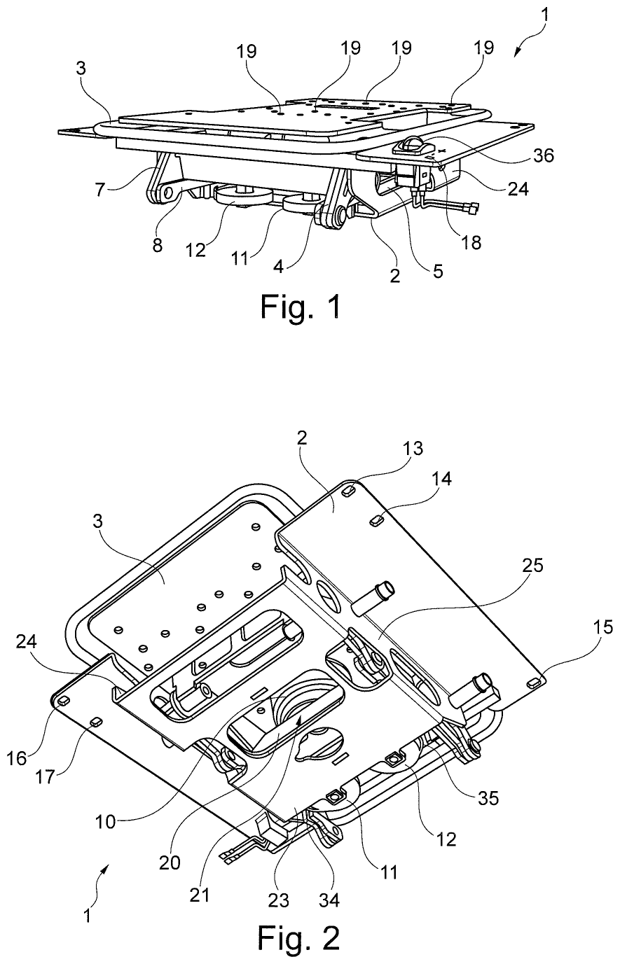

A device 1 according to the present invention comprises a lower part 2, an upper part 3, six actuating arms 4 to 9, a damping member 10 and two spring elements 11, 12 (FIGS. 1 to 4).

The lower part 2 has, for example, attachment means 13 to 18, the lower part 3 being able to be arranged thereby, in particular, in a positionally fixed manner, on a vehicle (not shown). The upper part 3 comprises attachment elements 19 in order to fasten a rotary unit (not shown) or a vehicle seat (not shown). For the sake of the clarity of the figures, not all of the attachment elements 19 of the upper part 3 are provided with a reference numeral.

The lower part 2 is advantageously configured to be U-shaped, for example, bent in a U-shaped manner. For example, the lower part 2 comprises two side elements 24, 25 oriented perpendicular to a lower face 23 of the lower part 2. The side elements 24, 25 are, for example, bent at an angle to the lower face 23 and are present so as to protrude from the lower part 2.

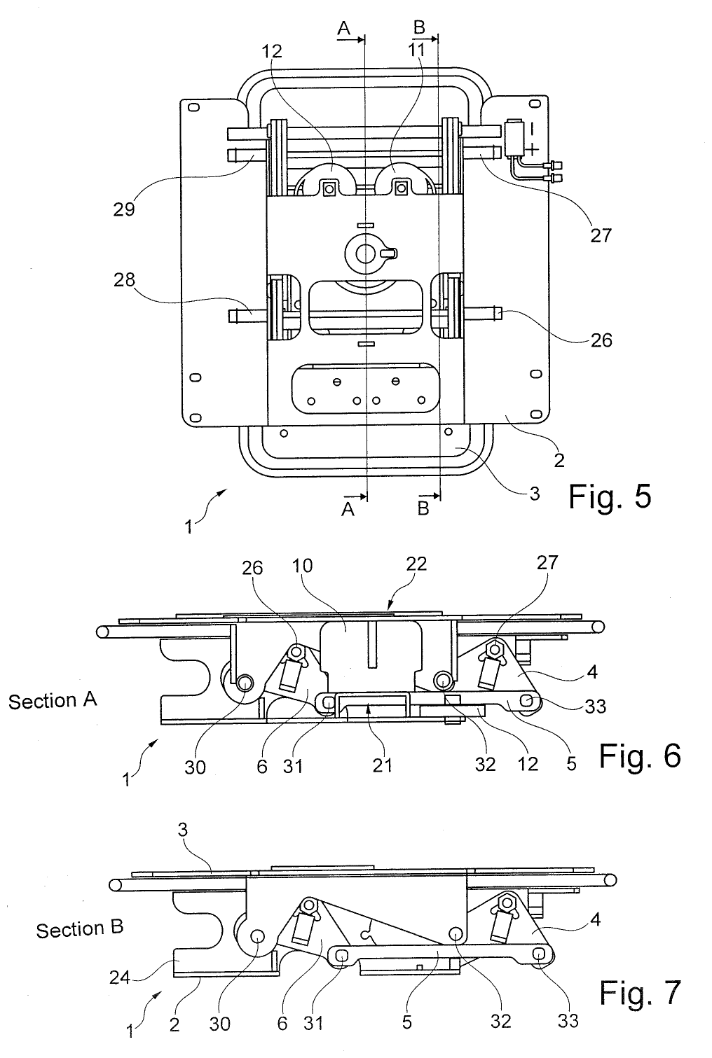

On a side element 24, 25 in each case two actuating arms 4, 6 and/or 7, 9 are rotatably mounted on one respective rotary pin 26, 27 and/or 28, 29. Each of the actuating arms 4, 6, 7, 9 which is rotatably mounted on a side element 24, 25 advantageously has two further rotary pins. In FIGS. 6, 7, the further rotary pins for a set consisting of the three actuating arms 4-6 are denoted by the rotary pin reference numerals 30-33. A further set consisting of the actuating arms 7-9 is advantageously present in an identical manner, for example, mirror-inverted relative to the actuating arms 4-6. The rotary pins 26 and 28 and/or 27 and 29 may also be present in each case as a single, in particular, continuous, rotary pin.

Each of the actuating arms 4, 6 is rotatably mounted on a first rotary pin 26, 27 on the lower part 2 and, pivotably, in particular, rotatably, connected to the upper part 3 via a further rotary pin 30, 32. Moreover, the actuating arms 4, 6 are movably coupled to a further actuating arm 5 by two further rotary pins 31, 33. As a result, the actuating arms 4-6 and the upper part 3 form a parallelogram which is advantageously connected so as to be pivotably movable relative to the lower part 2 via the rotary pins 26, 27.

The actuating arms 4, 6, 7, 9 have, for example, a triangular shape. As a result, the upper part 3 is able to be mounted in a movable manner relative to the lower part 2 via the actuating arms 4, 6, 7, 9 such that the upper part 3, when moved relative to the lower part 2, covers a comparatively large movement path in a vertical direction of movement relative to a horizontal direction of movement. In the arranged state of the device on the vehicle, the vertical direction of movement may be seen to be perpendicular to a direction of travel and in the direction of the vehicle floor and/or in the direction of the vehicle roof. The horizontal direction of movement may be seen to be parallel to the direction of travel.

The actuating arms 5, 8 are advantageously present as elongated and/or rod-shaped, in particular, rigid, actuating elements.

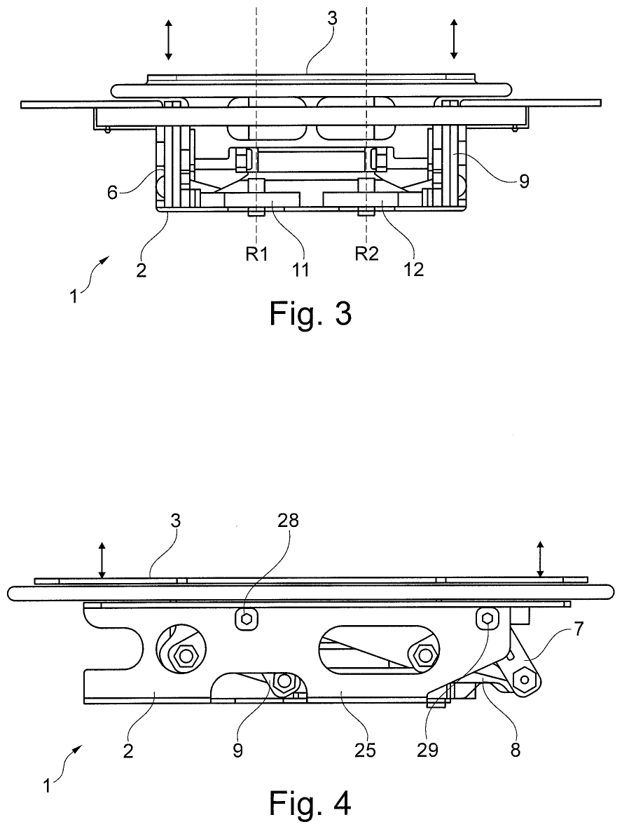

The damping member 10 is fastened, in particular, fixed, in a positionally fixed manner to a fastening element 20 of the lower part 2 by a first end 21. The damping member 10 is arranged, for example, mounted, in particular, fixed in a positionally fixed manner, on the upper part 3 by an opposing end 22 spaced apart from the first end 21. The damping member 10 is advantageously configured as a folding bellows. If the damping member 10 is subjected to compressed air, for example, the damping member 10 extends, in particular, in the vertical direction and thus pushes the upper part 3 away from the lower part 2 so that the vertical spacing between the lower part 2 and the upper part 3 increases (see FIGS. 3, 4). Due to its displacement on the lower part 2 via the actuating arms 4 to 9, the upper part 3 moves not only in the vertical direction away from the lower part 2 but also in the horizontal direction relative to the lower part 2. Advantageously, the upper part 3 moves approximately perpendicular to the lower part 2. The actuating arms 4, 6, 7, 9 in this case rotate about a rotational axis of the rotary pins 26-29.

When altering the spacing of the upper part 3 relative to the lower part 2 the actuating arms 5, 8 pivot both in the horizontal direction and in the vertical direction, wherein the horizontal movement component preferably predominates relative to the vertical movement component. Advantageously, the actuating arms 5, 8 move approximately parallel to the lower face 23 of the lower part 2.

The spring elements 11, 12 are configured, for example, as flat spiral springs and, for example, fastened, in particular fixed, to the lower part 2. The spring elements 11, 12 are, for example, fastened to the lower part 2 such that a rotational axis R1, R2 of the spring elements 11, 12 is oriented perpendicular to the lower face 23. In particular, the rotational axis R1, R2 of the spring elements 11, 12 is oriented in the vertical direction. One end 34 and/or 35 of the spring element 11 and/or 12 acts on the actuating arm 5 and/or 8 such that the spring element 11 and/or 12 acts with a spring force on the actuating arm 5 and/or 8. As a result, the spring element 11 and/or 12 acts, in particular, counter to a horizontal movement of the actuating arm 5 and/or 8 and thus, in particular, a vertical movement of the upper part 3 away from the lower part 2. The spring element 11 and/or 12 is arranged on the device 1 such that the upper part 3 is pulled by the spring force of the spring element 11 and/or 12 in the direction of the lower part 2. The spring element 11 and/or 12, for example, is arranged on the device 1 such that the spring force of the spring element 11 and/or 12 acts counter to an extension force of the damping element 10.

Advantageously the spring element 11 and/or 12 is configured and present on the device 1 such that, when moved, the upper part 3 does not reach a maximum spacing relative to the lower part 2 which is defined by the mechanism of the actuating arms 4-9.

The device 1 also comprises, for example, a switch 36, a supply line of the damping member 10 being controllable thereby. As a result, a pressure is adjustable inside the damping member 10.

### LIST OF REFERENCE NUMERALS

1 Device
2 Lower part
3 Upper part
4-9 Actuating arm
10 Damping member
11 Spring element
12 Spring element
13-18 Attachment means
19 Attachment element
20 Fastening element
21 End
22 End
23 Lower face
24, 25 Side element
26-33 Rotary pin
34, 35 End
36 Switch

1. A device for the height adjustment of a vehicle seat, wherein the device comprises a lower part for arranging on a vehicle, and an upper part for arranging a vehicle seat and/or for arranging a rotary unit for a vehicle seat, wherein the lower part and the upper part are coupled together via an actuating arm, wherein the device has a damping member present between the upper part and the lower part, wherein the damping member is configured to alter a spacing of the upper part relative to the lower part and wherein the device comprises a spring element present on the device such that it acts counter to a direction of extension of the damping member.

2. The device for the height adjustment of a vehicle seat as claimed in claim 1, wherein the device has two or more actuating arms, wherein the upper part and the actuating arms are arranged in a parallelogram-like manner and are present so as to be adjustable relative to one another.

3. The device for the height adjustment of a vehicle seat as claimed in claim 1, wherein the spring element is arranged on the lower part.

4. The device for the height adjustment of a vehicle seat as claimed in claim 1, wherein the upper part is movably mounted between a stop of the spring element and a stop of the damping member.

5. The device for the height adjustment of a vehicle seat as claimed in claim 1, wherein the spring element is arranged between the lower part and a first actuating arm, in such a manner that the spring element acts counter to a maximum extension.

6. The device for the height adjustment of a vehicle seat as claimed in claim 1, wherein a rotational axis R1, R2 of the spring element is present parallel to a direction of movement of the upper part.

7. The device for the height adjustment of a vehicle seat as claimed in claim 1, wherein the spring element is coupled to an actuating arm.

8. The device for the height adjustment of a vehicle seat as claimed in claim 7, wherein a pivot pin of an actuating arm is present on the lower part in a positionally fixed manner.

9. The device for the height adjustment of a vehicle seat as claimed in claim 1, wherein the device comprises at least six pivot pins.

10. The device for the height adjustment of a vehicle seat as claimed in claim 1, wherein the upper part is present so as to be rotationally movable relative to the lower part.

11. The device for the height adjustment of a vehicle seat as claimed in claim 1, wherein a spring force of the spring element is adjustable.

12. The device for the height adjustment of a vehicle seat as claimed in claim 1, wherein the device comprises a switch which is designed to control and/or to regulate an extension of the damping member.

13. A vehicle seat having a device as claimed in claim 1.

14. A vehicle having a device and/or a vehicle seat as claimed in claim 1.

15. The device for the height adjustment of a vehicle seat as claimed in claim 5, wherein the spring element acts counter to the damping member.

16. A device for the height adjustment of a vehicle seat, wherein the device comprises a lower part for arranging on a vehicle and an upper part for arranging a vehicle seat and/or for arranging a rotary unit for a vehicle seat, wherein the lower part and the upper part are coupled together via at least two actuating arms, wherein the device has a damping member, and wherein the upper part and the actuating arms are arranged in a parallelogram-like manner and are present so as to be adjustable relative to one another.
